(19) United States
(12) Patent Application Publication
(10) Pub. No.: US 2008/0033996 A1
(43) Pub. Date: Feb. 7, 2008

(54) Techniques for approximating the visual layout of a web page and determining the portion of the page containing the significant content

(76) Inventor: Anandsudhakar Kesari, Bangalore (IN)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 11/499,181

(22) Filed: Aug. 3, 2006

(51) Int. Cl. G06F 17/00; G06F 17/28

(52) U.S. Cl. 707/104.1; 715/244; 715/243; 715/238

(57) ABSTRACT

To approximate a visual layout of a web page without rendering the page, an object tree representing elements within the page is recursively traversed to determine bounds for the width of the elements, resulting in lower bounds induced for non-leaf nodes by elements within these nodes and upper bounds induced by ancestors and siblings of nodes. For each element, the minimum required width (lower bound), the desired width were there no constraints, and the maximum available width (upper bound) based on constraints of parents are computed, and an approximate width is derived therefrom. A positioning process positions each element within its corresponding parent container by advancing a cursor according to the elements' approximate width and appropriate constraints. The element that contains the most meaningful content is determined based on the amount of weighted content of elements and their position within the page.

### FIELD OF THE INVENTION

The present invention relates to computer networks and, more particularly, to techniques for approximating the visual layouts of web pages without rendering the pages.

### BACKGROUND OF THE INVENTION

### World Wide Web-General

The Internet is a worldwide system of computer networks and is a public, self-sustaining facility that is accessible to tens of millions of people worldwide. The most widely used part of the Internet is the World Wide Web, often abbreviated “WWW” or simply referred to as just “the web”. The web is an Internet service that organizes information through the use of hypermedia. The HyperText Markup Language (“HTML”) is typically used to specify the contents and format of a hypermedia document (e.g., a web page).

In this context, an HTML file is a file that contains the source code for a particular web page. A web page is the image or collection of images that is displayed to a user when a particular HTML file is rendered by a browser application program. Unless specifically stated, an electronic or web document may refer to either the source code for a particular web page or the web page itself. Each page can contain embedded references to images, audio, video or other web documents. The most common type of reference used to identify and locate resources on the Internet is the Uniform Resource Locator, or URL. In the context of the web, a user, using a web browser, browses for information by following references that are embedded in each of the documents. The HyperText Transfer Protocol (“HTTP”) is the protocol used to access a web document and the references that are based on HTTP are referred to as hyperlinks (formerly, “hypertext links”).

### Search Engines

Through the use of the web, individuals have access to millions of pages of information. However a significant drawback with using the web is that because there is so little organization to the web, at times it can be extremely difficult for users to locate the particular pages that contain the information that is of interest to them. To address this problem, a mechanism known as a “search engine” has been developed to index a large number of web pages and to provide an interface that can be used to search the indexed information by entering certain words or phases to be queried. These search terms are often referred to as “keywords”.

Indexes used by search engines are conceptually similar to the normal indexes that are typically found at the end of a book, in that both kinds of indexes comprise an ordered list of information accompanied with the location of the information. An “index word set” of a document is the set of words that are mapped to the document, in an index. For example, an index word set of a web page is the set of words that are mapped to the web page, in an index. For documents that are not indexed, the index word set is empty.

Although there are many popular Internet search engines, they are generally constructed using the same three common parts. First, each search engine has at least one, but typically more, “web crawler” (also referred to as “crawler”, “spider”, “robot”) that “crawls” across the Internet in a methodical and automated manner to locate web documents around the world. Upon locating a document, the crawler stores the document's URL, and follows any hyperlinks associated with the document to locate other web documents. Second, each search engine contains information extraction and indexing mechanisms that extract and index certain information about the documents that were located by the crawler. In general, index information is generated based on the contents of the HTML file associated with the document. The indexing mechanism stores the index information in large databases that can typically hold an enormous amount of information. Third, each search engine provides a search tool that allows users, through a user interface, to search the databases in order to locate specific documents, and their location on the web (e.g., a URL), that contain information that is of interest to them.

The search engine interface allows users to specify their search criteria (e.g., keywords) and, after performing a search, an interface for displaying the search results. Typically, the search engine orders the search results prior to presenting the search results interface to the user. The order usually takes the form of a “ranking”, where the document with the highest ranking is the document considered most likely to satisfy the interest reflected in the search criteria specified by the user. Once the matching documents have been determined, and the display order of those documents has been determined, the search engine sends to the user that issued the search a “search results page” that presents information about the matching documents in the selected display order.

### Information Extraction Systems

The web presents a wide variety of information, such as information about products, jobs, travel details, etc. Most of the information on the web is structured (i.e., pages are generated using a common template or layout) or semi-structured (i.e., pages are generated using a template with variations, such as missing attributes, attributes with multiple values, exceptions, etc.). For example, an online bookstore typically lays out the author, title, comments, etc. in the same way in all its book pages. Information Extraction (IE) systems are used to gather and manipulate the unstructured and semi-structured information on the web and populate backend databases with structured records. Most IE systems are either rule based (i.e., heuristic based) extraction systems or automated extraction systems. In a website with a reasonable number of pages, information (e.g., products, jobs, etc.) is typically stored in a backend database and is accessed by a set of scripts for presentation of the information to the user.

IE systems commonly use extraction templates to facilitate the extraction of desired information from a group of web pages. Generally, an extraction template is based on the general layout of the group of pages for which the corresponding extraction template is defined. One technique used for generating extraction templates is referred to as “wrapper induction”, which automatically constructs wrappers (i.e., customized procedures for information extraction) from labeled examples of a page's content. The wrapper induction technique is considered a computationally expensive technique. Hence, managing the amount of information and pages input to a wrapper induction process can thereby manage the overall computational cost of use for IE systems.

A common challenge for IE systems is to quickly and accurately extract information from HTML content. Hence, bypassing the useless content, in the context of information extraction, can be a valuable component in any information extraction process. To that end, some useful cues provided by HTML markup are (a) the style of the content, which includes color, emphasis, size, etc.; (b) the geometric layout of the elements of the page, such as the absolute placement of elements and the relative placement of a set of elements; and (c) the presence of a visually significant region in the document which appears to contain the main thrust of the content.

Crude approximations of the geometric layout of a page are made by assuming that the token distance between two elements in the HTML document code correlates with the geometric distance between those two elements when the document is rendered on a browser. This assumption fails in even moderately complicated cases. Some approximation approaches may not handle any page scenarios beyond the simplest of layouts, e.g., such approaches may not handle nested tables. Furthermore, using a full-fledged browser/rendering-engine to determine the geometric layout involves considerable computational expense, and the resolution of the geometric data with a browser is finer than required for purposes of a layout estimation, for example, for information extraction purposes. Hence, there is a need for fast, accurate, computationally inexpensive techniques for approximating the relative positions of elements within a web page, i.e., the visual layout of the web page, with quantifiable accuracy.

Any approaches that may be described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that illustrates an Information Integration System (IIS), in which an embodiment of the invention may be implemented;

FIG. 2 is a flow diagram that illustrates a method for approximating a visual layout of a web page, according to an embodiment of the invention;

FIG. 3 is a flow diagram that illustrates a method for approximating a most significant portion of a web page, according to an embodiment of the invention; and

FIG. 4 is a block diagram that illustrates a computer system upon which an embodiment of the invention may be implemented.

### DETAILED DESCRIPTION OF EMBODIMENTS OF THE INVENTION

Techniques are described for quickly approximating the visual layout of web pages without actually rendering the web pages, and for determining the portion of such pages considered to have the most significant content. One non-limiting further use of these approximations is for accurately and efficiently extracting information for indexing the content of such web pages.

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

### Functional Overview of Embodiments

The visual layout of a web page can be quickly approximated by modeling the HTML layout as a constraint-satisfaction process, where elements in the page are geometrically constrained by the geometric properties of corresponding parent container elements and surrounding elements. An object tree representing the elements within the page is recursively traversed to determine lower and upper bounds for the width of elements within the page, resulting in lower bounds induced for non-leaf nodes by elements within the nodes and upper bounds induced by ancestors and siblings of nodes. The complete approximation process operates without the need to actually render the web page and, therefore, is a computationally inexpensive process.

Because only an approximated layout is desired (i.e., the relative positions of elements rather than the exact positions within the page), some assumptions can be made without significant adverse effects and which provide significant gains in performance. For example, in one embodiment, it is assumed that all characters are of equal aspect ratio regardless of the font, i.e., fixed-width font, thereby allowing some tolerance in translation and scale of the page with an insignificant effect on the relative positions of elements within the page.

For each element under consideration, the minimum required width (lower bound), the desired width were there no constraints, and the maximum available width (upper bound) based on constraints of parents are computed, and an approximate width derived therefrom. A flow process positions each element within its corresponding parent container by advancing a cursor according to the elements' approximate width. The positional coordinates, approximate width and height are recorded for each element by annotating the object tree.

Furthermore, according to one embodiment, the most significant element of the web page is estimated, where the significance is based on containing most of the meaningful content. Determining the most significant element of the page is generally based on the amount of weighted content of elements and the position of the elements within the page as approximated by the visual layout process.

### System Architecture Example

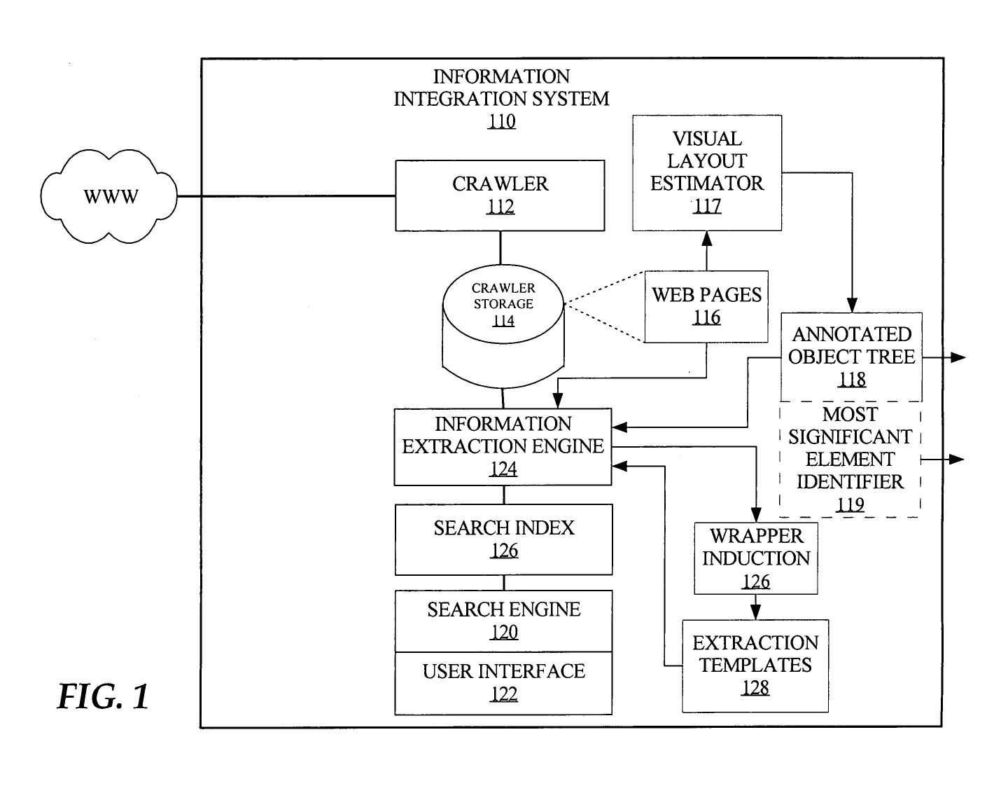

FIG. 1 is a block diagram that illustrates an Information Integration System (IIS), in which an embodiment of the invention may be implemented. The context in which an IIS can be implemented may vary. For non-limiting examples, an IIS such as IIS 110 may be implemented for public or private search engines, job portals, shopping search sites, travel search sites, RSS (Really Simple Syndication) based applications and sites, and the like. Embodiments of the invention are described herein primarily in the context of a World Wide Web (WWW) search system, for purposes of an example. However, the context in which embodiments are implemented is not limited to Web search systems. For example, embodiments may be implemented in the context of private enterprise networks (e.g., intranets), as well as the public network of networks (i.e., the Internet).

IIS 110 can be implemented comprising a crawler 112 communicatively coupled to a source of information, such as the Internet and the World Wide Web (WWW). IIS 110 further comprises crawler storage 114, a search engine 120 backed by a search index 126 and associated with a user interface 122.

A web crawler (also referred to as “crawler”, “spider”, “robot”), such as crawler 112, “crawls” across the Internet in a methodical and automated manner to locate web pages around the world. Upon locating a page, the crawler stores the page's URL, and follows any hyperlinks associated with the page to locate other web pages. The crawler also typically stores entire web pages 116 (e.g., HTML and/or XML code) in crawler storage 114.

Search engine 120 generally refers to a mechanism used to index and search a large number of web pages, and is used in conjunction with a user interface 122 that can be used to search the search index 126 by entering certain words or phases to be queried. In general, the index information stored in search index 126 is generated based on extracted contents of the HTML file associated with a respective page, for example, as extracted using extraction templates 128 generated by wrapper induction 126 techniques. Generation of the index information is one general focus of the IIS 110, and such information is generated with the assistance of an information extraction engine 124. For example, if the crawler is storing all the pages that have product descriptions, an extraction engine 124 may extract useful information from these pages, such as the product title, price, image, etc. and use this information to index the page in the search index 126. One or more search indexes 126 associated with search engine 120 comprise a list of information accompanied with the location of the information, i.e., the network address of, and/or a link to, the page that contains the information.

As mentioned, extraction templates 128 are used to facilitate the extraction of desired information from a group of web pages, such as by information extraction engine 124 of IIS 110. Further, extraction templates may be based on the general layout of the group of pages for which a corresponding extraction template is defined. For example, an extraction template 128 may be implemented as an XML file that describes different portions of a group of pages, such as a product image is to the left of the page, the price of the product is in bold text, the product ID is underneath the product image, etc. Wrapper induction 126 processes may be used to generate extraction templates 128.

Visual layout estimator 117 represents a code module that functions to compute approximate visual layouts of web pages without rendering the pages, according to techniques described herein. Visual layout estimator 117 accesses a web page, such as from web pages 116 stored in crawler storage 114, for creating an object tree of the page for further analysis and annotation, as described in greater detail herein. According to one embodiment, visual layout estimator 117 feeds an annotated object tree 118 to information extraction engine 124 for use in extracting interesting information from the web page represented by the annotated object tree 118. For example, IIS 110 may be provided information indicating that, for the particular web page and/or for similar types of pages (e.g., for product pages in a vertical shopping website), the sale price of a product is located an offset (x₁, y₁) from an image of the product and the product title is located (x₂, y₂) from the sale price, and the like. Additionally or alternatively to providing annotated object tree 118 to information extraction engine 124, visual layout estimator 117 may transmit the annotated object tree 118 to an entity or module outside of information extraction engine 124, for any use thereof. Hence, the foregoing example uses of approximations computed as described herein are non-limiting examples, because such approximations can be used for other purposes involving sectioning of web pages based on relative positioning, corresponding content, etc.

According to one embodiment, visual layout estimator 117 further functions to compute an estimated most significant element of a web page based at least in part on weighted amounts of content within different elements of the page, as described in greater detail herein. According to one embodiment, a most significant element identifier 119, which identifies the estimated most significant element of a web page, is provided to information extraction engine 124 of IIS 110 for focusing the extraction of information from that page. This is because the computed most significant element is known to be free of “noise” (e.g., navigation bars, banner or targeted ads, and the like) in the context of extracting meaningful content from the page. For example, the information extraction engine 124 can use the element name and/or page coordinates of the most significant element to limit its information extraction process to the identified most significant portion of the page. Additionally or alternatively to providing the most significant element identifier 119 to information extraction engine 124, visual layout estimator 117 may transmit the most significant element identifier 119 to an entity or module outside of information extraction engine 124, for any use thereof.

### Visual Layout Estimation

Techniques for estimating the visual layout of a web page, without rendering the page, are described and referred to generally herein as Visual Layout Estimation (“VLE”). VLE operates on an object tree (e.g., a DOM tree) that is constructed from an HTML document and represents the structure of the HTML elements within the document. The object tree is a fundamental data structure that maps HTML code elements to corresponding nodes in the object tree. This object tree for a given web page can be input to VLE, rather than inputting the entire HTML code for the web page.

HTML elements are broadly of two types:

formatting tags (e.g., BOLD, FONT, CENTER) which induce properties such as alignment, color, size, etc. on successor tags/elements; and

container tags (e.g., TABLE), which define bounding boxes within which elements are contained.

The basis of VLE is to model HTML layout as a constraint-satisfaction problem, where such techniques compute the relative positions of, preferably, a subset of elements within the page rather than the exact position of such elements. For example, VLE may determine that, for a particular product web page, the fixed price of a product is farther from the product title than the sales price, rather than determining that the fixed price is x number of pixels away from the sales price. Because relative positions are desired, VLE allows for errors (i.e., tolerance) in translation and scale of the elements within a page, but not for errors in the relative positions of the elements. Further, experimentation has shown the correlation between VLE's approximate visual layout and the actual graphically rendered layout of “standard” browsers to be sufficiently high.

VLE geometrically constrains elements in the page based on the geometric properties of corresponding parent container elements and surrounding elements. The object tree representing the elements within the page is recursively traversed to determine lower and upper bounds for the width of the various elements within the page, resulting in lower bound constraints induced for non-leaf nodes by elements within the non-leaf nodes and upper bounds induced by ancestors and siblings of nodes. The object tree is annotated with tuples of information for each node of at least a subset of the nodes, with the tuples representing the approximate 2-dimensional coordinates of the corresponding HTML elements (i.e., x-y coordinates relative to some origin) and the approximate width and height of the elements, where heuristics may be applied to the approximation process in order to resolve conflicts among elements and to optimize the layout approximation.

Width Estimation

At least a subset of the elements within a web page are analyzed for visual layout approximation purposes. For example, the VLE process may be tuned to exclude from processing any navigation bars or banners, e.g., by instructing the process to ignore tables or frames having a height that is over five times the width, ignoring portions of the page less than 5% down from the top of the page, and the like. Thus, the object tree is traversed to compute various width parameters corresponding to elements in the subset of elements that are considered of interest.

Parameters referred to as “minimum width”, “desired width”, “available width”, and “approximate width” are described herein. The width parameters are used to define the walls of bounding boxes within which elements are subsequently laid out. Starting with the top element of the subset of elements in a web page, such as the <BODY> element/tag, the object tree is recursively traversed from top-down in order to compute the minimum widths of each HTML element and table column, where the top element is constrained to the width of a browser window (e.g., the number of pixels wide). This is the available width for the top element, including all sub-trees of the top element. Other elements must be wide enough to fit corresponding child elements and tables wide enough to fit corresponding columns. For example, nested tables must be big enough to fit the sum of the widths of all their corresponding columns. Thus, the minimum width of a particular HTML element is the width of the widest child element or column of the particular element.

A first parameter, the minimum width, is computed for each of the elements in the subset. The minimum width for elements corresponding to leaf nodes are determinable as their pixel width, such as the actual pixel width of an image leaf, and the specified or calculated pixel width of a text leaf. For example, moving from a paragraph tag, <P>, to a bold tag, <B>, both elements must be at least wide enough to contain the corresponding children, such as the width of the bolded word(s) that are children of the bold tag. According to one embodiment, all text characters of the same font style and point size are assumed be of equal width (e.g., an “1” is the same width as a “w”), with a constant aspect ratio. However, according to a related embodiment, if the size of a font is explicitly defined (e.g., by the number of pixels per character), the explicit definition is not ignored and is considered when computing the corresponding widths. Eventually, the minimum widths of the elements are propagated back up the object tree to compute the minimum widths of container elements.

For text nodes, the minimum width is the width of the longest word at that text node. Stated otherwise, to account for text that is not a word, the minimum width for a text element is the width of the longest sub-element in the text element, where a sub-element is a set of continuous characters without a space and where the longest sub-element is the sub-element having the most characters. For image nodes, the exact width of the image is known based on the parameters of the image. Therefore, the actual width of the image is used as the minimum width in further processing. In the case where the width and height of the image are not explicitly specified in the HTML code, the image is fetched and the image dimensions are determined from the fetched file.

For table nodes, the minimum width of a table is the sum of the minimum widths of all the columns in the table, where the minimum width of each column is the width of the largest cell in each column. Further, in the special case of a floating DIV tag, which is a block level HTML element that defines a block of content in the page, the surrounding text outside of the DIV block is treated as wrapping around the block formed by the DIV tag.

By recursively traversing the object tree, the lower bound minimum widths are thereby computed for each element, both leaf and non-leaf, in the subset of elements under consideration, as described. With an approximated layout as the goal, a further assumption applied to the VLE process is that all elements that appear (geometrically) inside another container element are present in the container element's corresponding node sub-tree.

A second parameter for each HTML element, the desired width, is the width that the element would occupy if there were no geometric constraints on the element. For example, for a paragraph of text contained within a table, but not constrained by the boundaries of the table, the paragraph would fit within a single line of the non-constraining table. Therefore, the desired width of the paragraph would the width of a line long enough to fit the entire paragraph of text. The desired widths of the elements serve as upper bounds on the respective element widths, with a goal of providing enough space for the element to occupy as close to its desired width as possible, without violating the constraints imposed by container elements. The desired width of a parent container element is the sum of the desired widths of all the parent's children elements. Now having computed the minimum and desired widths for each HTML element in the web page under consideration, the lower and upper bounds are now known for each element.

A third parameter for each HTML element, the available width, is the total space available for an element considering the constraints imposed by parent container elements. The available widths for child elements are constrained by the width of corresponding parent elements. Thus, the object tree is recursively traversed from the root node down to the leaf nodes, to compute the available width for each corresponding element in view of the constraints imposed by respective parent elements. The available width functions as a second upper bound on the width of an element, in addition to the desired width associated with the element.

Based on the minimum, desired and available widths for each element, an “approximate width” for the element is computed. The approximate width is not necessarily the actual width of the element as if it was graphically rendered in a browser window according to all of the element attributes specified in the HTML code, but an approximate width of the element for purposes of approximating the overall visual layout of the page, i.e., the relative proximity among elements within the page. Returning to the model of the visual layout problem as a constraint-satisfaction problem, the approximate widths are considered as the satisfactions to all the constraints imposed upon elements by other elements, such as sibling and ancestor and neighboring elements.

A “real” actual width for an element, i.e., the actual width of the element if it was graphically rendered in a browser window according to all of the element attributes specified in the HTML code, may be explicitly specified in the code. For example, a table width may be defined in the code by one or more associated attributes, such as by the number of pixels wide, or a percentage of a parent element, and the like. In computing the approximate width, such specified real actual widths are treated as hints for computing the corresponding approximate width. According to one embodiment, if the computed minimum width for and element is less than the specified width for the element, then the minimum width is changed to the specified width for purposes of resolving the approximate width for the element. If the specified width is less than the computed minimum width, then the specified width is not respected and the computed minimum width is used for purposes of resolving the approximate width.

For a given element, there could be many width values that satisfy the corresponding constraints on that element. According to one embodiment, the approximate width is computed in terms of a number of pixels. According to one embodiment, a feasibility function is used to compute the best approximate widths recursively based on the minimum, desired, available, and specified width parameters, where the approximate width for an element is (a) equal to or greater than the minimum width for the element; (b) less than the available width, i.e., the bounding box width; and (c) as close as possible to the desired width; and (d) in accordance with the specified width attribute to the extent possible. For examples of (d), if the real actual width for an element is specified as a percentage value of a ancestor element, then the approximate width is set to that same percentage of the available width if possible without violating a constraint, and if the real actual width is specified as a pixel value, then this pixel value is used if possible without violating a constraint.

For elements that can wrap to a next line (e.g., non-table elements), the largest feasible value for an element is computed as the element's approximate width, with consideration to the element's bounding constraints (e.g., minimum width and available width) and as close as possible to the element's desired width.

Columns of tables are unable to wrap to the next line. For tables, the cells contained therein are constrained by neighboring cells. The width of a cell may be explicitly specified by a <TD> tag. The exact width of every cell is computed and then fit into a grid whose outer boundaries are constrained as follows. If the table width is specified as an attribute, then this specified table width is used as the bounding box for the cells. Otherwise, either the available width or the desired width for the table is used, whichever is smaller.

Every column in the table is initially assigned the column's corresponding minimum width as an initial approximate width. However, the sum of minimum widths of all columns in the table may not add up to the computed table width. Hence, a column may be adjusted to approach the column's desired width. The amount by which the minimum width of the table is less than the computed width for the table is referred to as the “free width.” If there is free width for the table, then the free width is distributed among columns having variable-width type, based on corresponding deficits. A column's “deficit” is the amount by which the column's minimum width is less than the column's desired width. If a column has a small deficit (e.g., as a percentage of it desired width), then the column's approximate width is increased to the column's desired width and the table free width is correspondingly decreased. Any remaining free width is distributed among the variable-width columns in proportion to their deficit, thereby minimizing the deficit of each column.

At this point in the VLE process, good estimates of the width of each HTML element (i.e., the approximate width) have been computed. However, where each element is laid out horizontally and vertically in the page has yet to be determined.

Positional Placement

In the positional placement phase of the VLE process, all the children of a parent (container) element are positioned within the bounding box defined by the parent using an automated cursor or other position indicator/locator. The bounding box associated with the top element, <BODY>, consumes the entire width and the (as yet unknown) height of the page. Starting at the top and beginning vertical boundary of the bounding box (e.g., left wall for left-aligned content that is read left to right), each child element is placed recursively at the current position of the cursor, according to its approximate width, and the cursor is advanced in order to place the next child element (e.g., from left to right for content that is read from left to right). The vertical spacing is according to the line spacing and element size specified in the HTML code, such as font point size, image height, etc. In one embodiment, the line spacing is fixed as 1.5 and the font point-size and image dimensions are determined from the HTML code. The cursor wraps to the next line when the cursor reaches the ending vertical boundary of the bounding box (e.g., right wall for left-aligned content that is read left to right). Note that for languages that are read right to left, the beginning vertical boundary would be the right wall of the bounding box and the ending vertical boundary would be the left wall of the bounding box, and the cursor would advance from right to left.

Some elements have a fixed starting and ending position of the cursor, such as a paragraph tag, <P>, always starts and ends on a new line at the left of the bounding box. The bottom boundary of each bounding box is movable. As elements are laid out by the cursor, a bottom boundary is moved down if necessary. Hence, the height of a container is determined by the final position of the container's bottom boundary, after laying out all the contained child elements. For a table element, the current line is ended and the cursor advances to the next line. Each row and each column for each row is positioned, according to the corresponding approximate widths, whereby the height of all cells in a row is equal to the height of the tallest cell in the row and the width of all cells in a column is equal to the width of the widest cell in the column.

A cell can span multiple rows of a table. Thus, the boundary wall for a number of rows adjacent to the spanning cell is affected. For example, if a cell spans five rows but only a first column of a table, then the second column of the five rows are bounded on their left by the right boundary wall of the spanning cell. Hence, the cells associated with the adjacent five rows are placed according to this left boundary wall imposed by the right boundary wall of the spanning cell.

According to one embodiment, the object model is annotated with the node geometric information (x-y, width, height) as the cursor is advancing through the placement flow process. Based on the cursor location for placing an element, the x-y coordinates of a certain origin/point for the element, relative to a certain origin for the page, are determined. Furthermore, the height is determined based on the vertical spacing for the line in which the element is placed, and the approximate width was already computed. Therefore, the geometric information is associated with each node in the object tree to generate an annotated object tree. The annotated object tree now represents the approximate visual layout computed by the VLE process.

### A Method for Approximating a Visual Layout of a Web Page

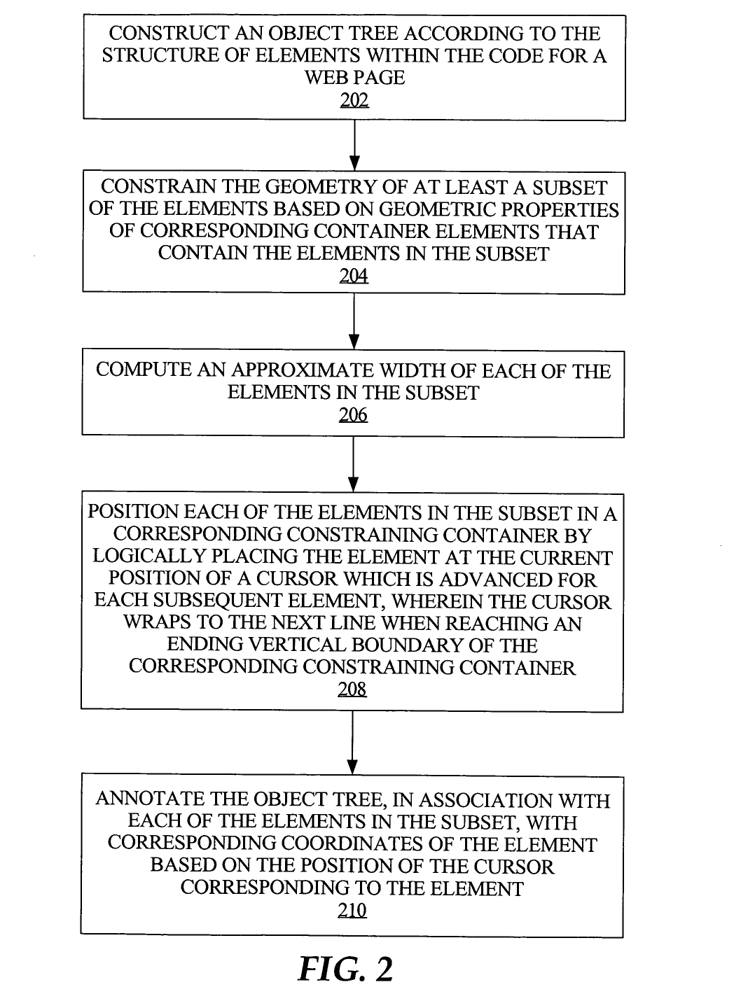

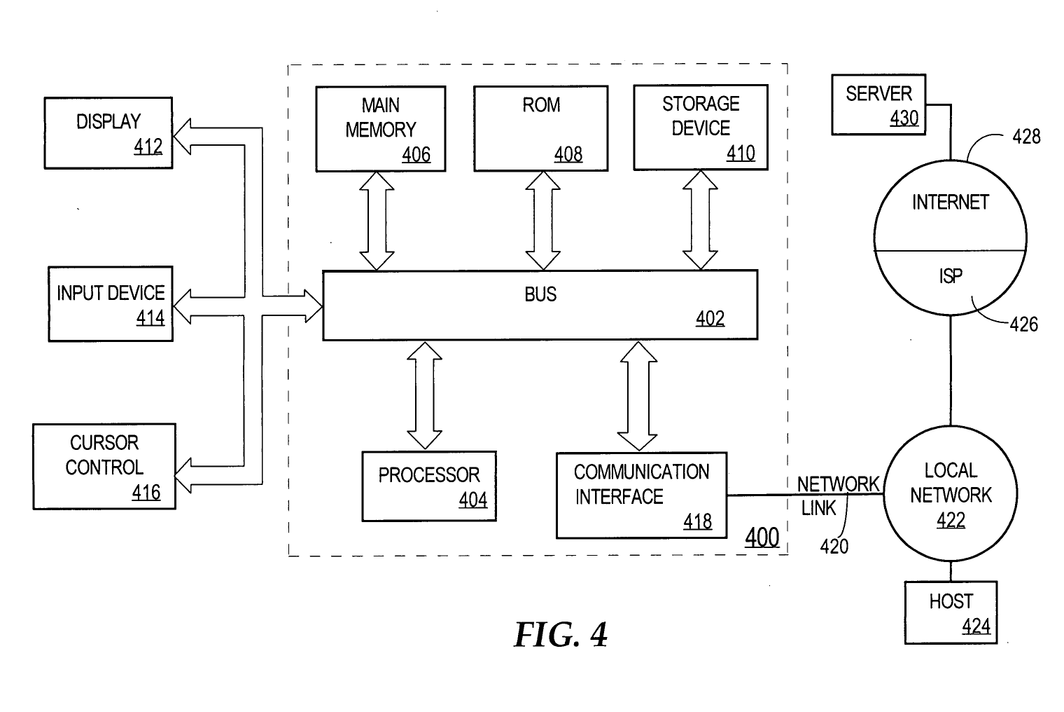

FIG. 2 is a flow diagram that illustrates a method for approximating a visual layout of a web page, according to an embodiment of the invention. FIG. 2 is implemented for automated performance by a conventional computing system, such as computer system 400 of FIG. 4. Further, according to an embodiment, the process illustrated in FIG. 2 is implemented for automated performance within a software system architecture, such as that illustrated in FIG. 1.

At block 202, an object tree is constructed for a Web page according to the structure of the Web page. For example, a DOM (document object model) tree is constructed according to the Web page HTML code.

At block 204, the geometries of at least a subset of the elements are constrained based on the geometric properties of corresponding container elements that contain elements in the subset.

At block 206, an approximate width is computed for each of the elements in the subset. For example, the approximate widths of elements are based on the elements' minimum, desired and available widths, as described herein.

At block 208, each of the elements in the subset are positioned in a corresponding constraining container by logically placing the element at the current position of a cursor, which is advanced for each subsequent element. For example, placing starts at a beginning vertical boundary of the corresponding constraining container and advances to an ending vertical boundary of the corresponding constraining container, where the cursor wraps to the next line when reaching the ending vertical boundary. For languages that are read from left to right, the cursor would advance from the left wall to the right wall and wrap to the next line when reaching the right wall. Likewise, for languages that are read from right to left, the cursor would advance from the right wall to the left wall and wrap to the next line when reaching the left wall.

At block 210, for each of the elements in the subset, the object tree is annotated with at least the corresponding coordinates of the element based on the position of the cursor corresponding to the element.

### Most Significant Element Estimation

According to one embodiment, the most significant element (MSE) of a web page is estimated, where the significance is based on the element containing most of the meaningful content, including the elements sub-trees. Determining the most significant element of the page is generally based on the amount of weighted content of elements and the position of the elements within the page as approximated by the visual layout process. The most significant element of a page is identified as such (e.g., by most significant element identifier 119 of FIG. 1). The MSE process can operate independently of the VLE process described herein, or can utilize the annotated object tree output from the VLE process. For example, the approximate visual layout output from the VLE process may provide valuable information to the MSE process, such as whether an element, if rendered, would be visible upon rendering or would require scrolling down to be visible. Whether or not to tie the MSE process to the VLE process may vary from implementation to implementation.

Intuitively, the most significant element of a web page is the element that contains the most meaningful content. The most significant element may tend toward different types of elements depending on what is considered meaningful in any given context. For example, in the context of product-related pages, the most significant element may be a table element, whereas in some other context the most significant element may be a text element, image element, etc. Consequently, the process that automatically computes the most significant element is tunable to users' needs, as described in greater detail herein.

According to one embodiment, the “content” of an element is defined as a weighted sum of the number of words and the dimensions of images contained in the element and the element's sub-tree. Generally, the MSE is characterized by as an element with (a) significant amount of content, and (b) exactly the thrust of the page, free from ‘noise.’ These characteristics give rise to a pair of conflicting objectives. It follows from (a) that the element must be close to the root because the <BODY> tag contains all the content and each sub-tree has lesser content than its predecessors. On the other hand, (b) entails the MSE being deeper within the DOM tree, because elements at the top of the DOM tree contain most of the ‘noise’ (e.g., banner advertisements, navigation bars, etc.).

According to one embodiment, the content of an element is weighted by the following factors.

Formatting: text with ancestors such as BOLD, SMALL, HI, etc. is assigned relatively more weight than other text.

Grid: the presence of a grid structure, such as a visible border or cell spacing in a table element is assigned relatively more weight than other tables.

Distance from top: elements are assigned a weight as a function of their distance from the top of the page. One weighting function associated with this embodiment assigns maximum weight to elements which are placed close to the vertical center of the browser window (which is assumed to be of typical height), and assigns extremely low weight to elements which are far enough from the top of the page to not be visible in the browser window (of typical height) without scrolling.

As mentioned, the MSE process is tunable, in that parameters can be added for tuning the process to a corresponding task. For example, the process may be tuned with a condition on the minimum width of a table for a table to qualify as the MSE, specified in terms of the number of pixels or the percentage of the window width, for example. Consequently, such a minimum-width constraint excludes navigation tables at the left and right sides, which are typically vertically long and horizontally narrow tables. For another example, the process may be tuned to ensure that the table is approximately centered, for example, with a condition such as “width>50%” of window width. Any possible measure associated with HTML elements within the web page can be used to tune the MSE process to fulfill the needs of a corresponding task or use context. For other non-limiting examples, certain types of elements may be assigned greater weight, certain types of images may be assigned greater weight, text that includes hyperlinks may be assigned greater weight, and the like.

When the object tree is descended from the root, the content of subsequent elements decreases. According to one embodiment, the “content-loss” in descending from element E0 to element E1 is defined as:

content-loss(E0−>E1)=content(E0)−content(E1).

The “true-content” of an element E0 is defined as the content-loss in descending from E0 into the child node of E0 that has the maximum content among all the child node's siblings. For example, if much of the content of a table is contained within one of the table's sub-tables, this parent table should not and will not qualify as an MSE because most of the significant information is in the sub-table. Hence, the parent table should not take ownership of the content in the sub-table. Each element is effectively ranked by its corresponding true-content. It is undesirable for the true-content of the MSE to be relatively small and, therefore, it is desirable for the true-content of the MSE to be sufficiently and relatively large. Furthermore, the MSE is expected to be contained in the sub-tree (of the object tree) with the maximum content among all the sub-trees. The foregoing two criteria are considered, in descending into the object tree along the path having maximum content, i.e., the path having the “real” content because this path would include the largest child of the root in comparison with, for example, navigation bars and/or banner ads. This maximum content path is descended down until the true-content of an element falls below a certain threshold value. When the true-content of the element which was descended into (e.g., E2) falls below a certain threshold value, then the corresponding parent element (e.g., E1) is determined to be the MSE. Stated otherwise, if the content-loss from element E1 to E2 exceeds a certain threshold, then descending is terminated and element E1 is determined to be the MSE. Finally, the most significant portion of the web page comprises the most significant element and the most significant element's sub-tree, if any

### A Method for Approximating the Most Significant Element of a Web Page

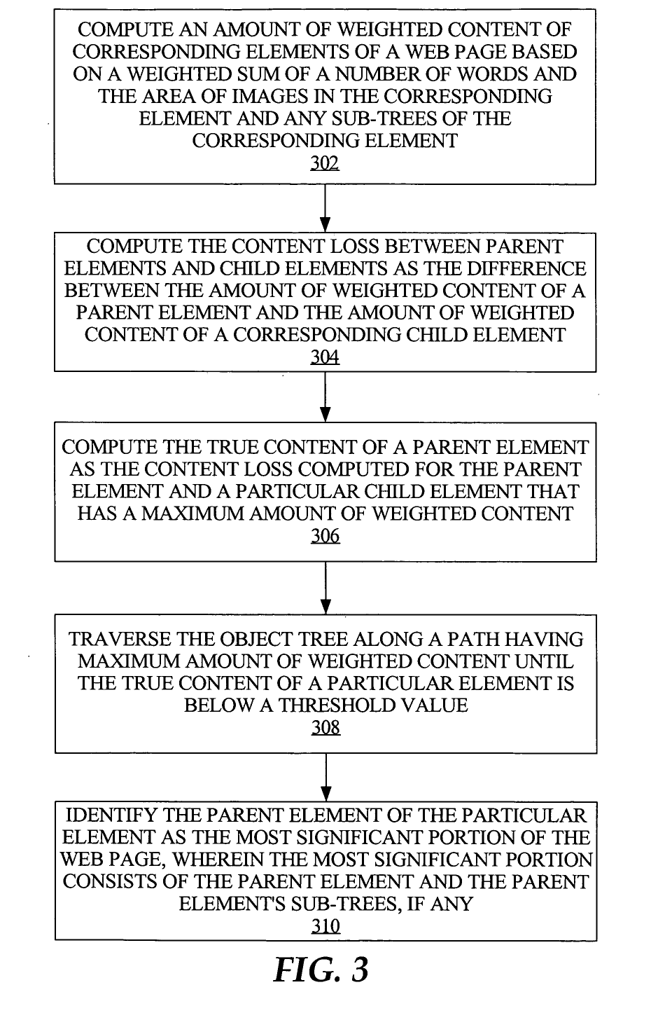

FIG. 3 is a flow diagram that illustrates a method for approximating a most significant portion of a web page, according to an embodiment of the invention. FIG. 3 is implemented for automated performance by a conventional computing system, such as computer system 400 of FIG. 4. Further, according to an embodiment, the process illustrated in FIG. 3 is implemented for automated performance within a software system architecture, such as that illustrated in FIG. 1.

At block 302, the amount of weighted content of corresponding elements of a web page is computed based on a weighted sum of the number of words and the area of images in the corresponding element and any sub-trees of the element, as described herein.

At block 304, the content loss between parent elements and child elements is computed as the difference between the amount of weighted content of a parent element and the amount of weighted content of a corresponding child element. For example, the content loss between two elements E0 and E1 is computed according to the following, content-loss(E0−>E1)=content(E0)-content(E1), as described herein.

At block 306, the true content of a parent element is computed as the content loss computed for the parent element and a particular child element that has the maximum amount of weighted content, as described herein.

At block 308, an object tree representing the structure of the web page is traversed along the path having the maximum amount of weighted content until the true content of a particular element is below a threshold value.

At block 310, the parent element of the particular element is identified as the most significant portion of the web page, consisting of the parent element and any sub-trees of the parent element.

### Hardware Overview

FIG. 4 is a block diagram that illustrates a computer system 400 upon which an embodiment of the invention may be implemented. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for implementing the techniques described herein. According to one embodiment of the invention, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 400, various machine-readable media are involved, for example, in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution. In this manner, computer system 400 may obtain application code in the form of a carrier wave.

### Extensions and Alternatives

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

Alternative embodiments of the invention are described throughout the foregoing specification, and in locations that best facilitate understanding the context of the embodiments. Furthermore, the invention has been described with reference to specific embodiments thereof. It will, however, be evident that various modifications and changes may be made thereto without departing from the broader spirit and scope of the invention.

In addition, in this description certain process steps are set forth in a particular order, and alphabetic and alphanumeric labels may be used to identify certain steps. Unless specifically stated in the description, embodiments of the invention are not necessarily limited to any particular order of carrying out such steps. In particular, the labels are used merely for convenient identification of steps, and are not intended to specify or require a particular order of carrying out such steps.

What is claimed is:

1. A method comprising performing a machine-executed operation involving instructions for approximating the visual layout of a Web page, wherein the machine-executed operation is at least one of:
A) sending said instructions over transmission media;
B) receiving said instructions over transmission media;
C) storing said instructions onto a machine-readable storage medium; and
D) executing the instructions;
wherein said instructions are instructions which, when executed by one or more processors, cause the one or more processors to perform the steps of:
constructing an object tree according to a structure of elements within Web page code; and
approximating a visual layout of said Web page without rendering said Web page, wherein said approximating a visual layout comprises:
constraining the geometry of at least a subset of said elements based on geometric properties of corresponding container elements that contain said elements in said subset,
computing an approximate width of each of said elements in said subset, wherein said approximate width of an element may be different than a width for said element as specified in said Web page,
positioning each of said elements in said subset in a corresponding constraining container by logically placing the element at the current position of a locator which is advanced for each subsequent element, and
annotating said object tree in association with each of said elements in said subset, with corresponding coordinates of the element based on the position of said locator corresponding to the element.

2. The method of claim 1, wherein said step of computing an approximate width comprises computing an approximate width for each of said elements in said subset based on (a) a minimum required width for the element, (b) a width the element would occupy if there was no constraint on the element, and (c) a width available for the element based on one or more constraints imposed by the width of the container element in which the element is contained.

3. The method of claim 2, wherein said step of annotating comprises annotating said object tree in association with each of said elements in said subset, with said approximate width of the element and an approximate height of the element.

4. The method of claim 2, wherein said step of computing an approximate width of each of said elements in said subset comprises the steps of:
computing said minimum required width for each container element by recursively computing a corresponding minimum width required to contain all child elements of the container element.

5. The method of claim 4, wherein said step of computing an approximate width comprises computing a minimum required width of a text element as the width of the longest sub-element in said text element, wherein a sub-element is a set of continuous characters without a space, and wherein said longest sub-element is the sub-element having the most characters.

6. The method of claim 4, wherein said step of computing an approximate width of a table element comprises the steps of:
computing a minimum width for each column in said table element as the width of the largest cell in the column; and
computing an initial approximate width of said table element as a sum of the minimum widths of all the columns in said table element.

7. The method of claim 6, wherein said step of computing an approximate width of a table element comprises the steps of:
if a table width for said table element is specified in said Web page, then comparing said initial approximate width of said table element with said specified table width of said table element;
if said initial approximate width of said table element is less than said specified table width, then distributing the difference between said specified table width and said initial approximate width to columns having variable-width type, wherein said distributing is in proportion to a difference between said minimum width for said variable-width column and a width the variable-width column would occupy if there was no constraint on the variable-width column.

8. The method of claim 4, wherein said step of computing an approximate width comprises computing a minimum required width of an image element as the actual width of said image element.

9. The method of claim 4, wherein said step of computing an approximate width comprises:
computing a minimum required width of a text element as the width of the longest sub-element in said text element, wherein a sub-element is a set of continuous characters without a space, and wherein said longest sub-element is the sub-element having the most characters;
computing a minimum required width of a table element as a sum of the minimum widths of all columns in said table element, wherein the minimum width of a column is the width of a largest cell in said column; and
computing a minimum required width of an image element as the actual width of said image element.

10. The method of claim 2, wherein said step of computing an approximate width of each of said elements in said subset comprises the steps of:
computing a desired width of the element as the width the element would occupy if there was no constraint on the element; and
wherein said instructions are instructions which, when executed by one or more processors, cause the one or more processors to perform the steps of:
recursively computing the desired width of each container element as a sum of the desired widths of all child elements of the container element.

11. The method of claim 2, wherein said step of computing an approximate width of each of said elements in said subset comprises the steps of:
if a width for an element in said subset is specified in the Web page, and if the minimum required width for the element is less than said specified width, then computing the approximate width for the element as said specified width.

12. The method of claim 2, wherein said step of computing an approximate width of each of said elements in said subset comprises the steps of:
if a width for an element in said subset is specified in the Web page, and if the minimum required width for the element is greater than said specified width, then computing the approximate width for the element as said minimum required width.

13. The method of claim 1,
wherein said step of positioning each of said elements comprises positioning each of said elements in said subset in an order, based on the object tree, from a root element down through one or more branches of said object tree to a corresponding leaf element; and
wherein said instructions are instructions which, when executed by one or more processors, cause the one or more processors to perform the steps of:
computing the height of each container element based on a movable bottom boundary of said container element, wherein the bottom boundary is based on a final position of the elements contained in said container element.

14. The method of claim 1, wherein said instructions are instructions which, when executed by one or more processors, cause the one or more processors to perform the step of:
computing a most significant portion of the Web page based on an amount of weighted content in said most significant portion.

15. The method of claim 14, wherein said instructions are instructions which, when executed by one or more processors, cause the one or more processors to perform the steps of:
computing said amount of weighted content of corresponding elements based on a weighted sum of a number of words and the area of images in said corresponding element and one or more sub-trees of said corresponding element;
computing a content loss between parent elements and child elements as the difference between said amount of weighted content of a parent element and said amount of weighted content of a corresponding child element;
computing a true content of a parent element as said content loss computed for said parent element and a particular child element, of said parent element, that has a maximum amount of weighted content;
traversing the object tree along a path having maximum amount of weighted content until said true content of a particular element is below a threshold value; and
identifying a parent element of said particular element as said most significant portion of said Web page, wherein said most significant portion comprises said parent element and said parent element's sub-trees if any.

16. The method of claim 14, wherein said instructions are instructions which, when executed by one or more processors, cause the one or more processors to perform the steps of:
informing an information extraction process of said most significant portion of said Web page.

17. The method of claim 14, wherein said step of computing a most significant portion of said Web page comprises computing said amount of weighted content in an element of said Web page based on weighting said content of said element based on one or more of (a) text formatting specified for said element in said Web page code, (b) a border or cell spacing specified, for a table element, in said Web page code, and based on weighting the depth of said element in said object tree.

18. The method of claim 1, wherein said Web page is coded at least in part in HTML.

19. The method of claim 18, wherein said Web page resides on a private network.
